(19) United States
(12) Patent Application Publication
(10) Pub. No.: US 2022/0259440 A1
(43) Pub. Date: Aug. 18, 2022

(54) TWO-COMPONENT ADHESIVE COMPOSITION COMPRISING A BORANE-AMINE COMPLEX

(71) Applicants: BOSTIK SA, Colombes (FR); CENTRE NATIONAL DE LA RECHERCHE SCIENTIFIQUE, Paris (FR); UNIVERSITE DE BORDEAUX, Bordeaux (FR); INSTITUT POLYTECHNIQUE DE BORDEAUX, Talence Cedex (FR)

(72) Inventors: Guillaume MICHAUD, VENETTE (FR); Boris COLIN, VENETTE (FR); Frédéric SIMON, VENETTE (FR); Stéphane FOUQUAY, VENETTE (FR); Virginie LIAUTARD, TALENCE CEDEX (FR); Mathieu PUCHEAULT, TALENCE CEDEX (FR)

(21) Appl. No.: 17/626,150

(22) PCT Filed: Jul. 9, 2020
(86) PCT No.: PCT/FR2020/051238

§ 371 Date: Jan. 11, 2022

(30) Foreign Application Priority Data
Jul. 18, 2019 (FR) FR1908161

(51) Int. Cl. C09D 4/00; C09J 175/16; C09J 4/06; C08G 18/69; C08G 18/67; C08G 18/63; C08G 18/50; C08G 18/32; C08G 18/28; C08G 18/10; C08F 290/06

(52) U.S. Cl. CPC C09D 4/00; C09J 175/16; C09J 4/06; C08G 18/69; C08G 18/672; C08F 290/067; C08G 18/5024; C08G 18/3268; C08G 18/288; C08G 18/2865; C08G 18/10; C08G 18/637

(57) ABSTRACT

The invention relates to a two-component composition comprising:

a part A comprising a complex of borane BH₃ with an amine;

a part B comprising a decomplexing agent for decomplexing the borane and the amine; and

at least one radically polymerizable compound comprising at least one ethylenic bond, this compound being present in at least one of parts A and B; and also to the use of this composition as an adhesive for binding two substrates together.

### FIELD OF THE INVENTION

The present invention relates to a two-component composition and also to the uses of said composition. The invention also relates to articles manufactured with this composition and to methods for preparing said articles.

### TECHNICAL BACKGROUND

The nature of the surface of a substrate can be characterized by its surface energy. Low surface energy substrates, such as polyolefins (polyethylene, polypropylene, polybutene, polyisoprene, polybutadiene, polyfarnesene, polymyrcene, polydicyclopentadiene and the copolymers thereof), polyvinyl fluoride (PVF), polyvinylidene fluoride (PVDF), polytetrafluoroethylene (PTFE), are known to be difficult to bond to each other or to other types of substrates and often require surface treatment prior to bonding. This treatment may also be necessary in the case in which the substrate has to be coated or treated with a layer. This is because the surface of the substrate is chemically inert due to the saturated carbon-carbon bonds. These treatments, such as a plasma or corona treatment, an abrasion treatment or a treatment with a chemical agent, consist in chemically and/or physically modifying the surface of the substrate in order to favorably modify its surface energy.

However, this type of treatment has a certain number of disadvantages, such as a high process cost, results which are not necessarily reproducible, and an effect which diminishes over time.

Recently, it has been discovered that the use of adhesive compositions comprising organoboranes makes it possible to improve the adhesion of compounds that can be polymerized by a radical route on low-energy surfaces. However, due to the unstable and pyrophoric nature of organoboranes, they must be complexed with an amine in order to avoid oxidative decomposition. This type of composition is often in the form of two parts (one of the two parts comprising the organoborane-amine complex and one comprising an agent which is reactive with the organoborane-amine complex such as a decomplexing agent) which are mixed just before the use and application of the composition.

Document U.S. Pat. No. 2,973,337 describes the polymerization of unsaturated compounds comprising one or more ethylenic bonds, using catalysts of borazane type.

Document U.S. Pat. No. 8,202,932 relates to polymerizable (meth)acrylic compositions and adhesive systems prepared from these compositions. These compositions comprise an alkylated borohydride or a tetraalkylborane metal or ammonium salt and an aminosilane. According to this document, these compositions are suitable for bonding applications involving at least one low-energy surface.

Document U.S. Pat. No. 6,632,908 relates to (meth)acrylic compositions used for the adhesion of metal, plastic or glass substrates to substrates of the same nature or of a different nature, such as substrates having a low-energy surface. The (meth)acrylic compositions described in this document comprise a (meth)acrylate compound and an initiator system comprising an organometallic compound, a peroxide compound, an aziridine-based compound and a compound having an acid function.

Document U.S. Pat. No. 9,315,701 describes a two-part adhesive composition comprising an organoborane-amine complex, a polyamine, a radically polymerizable compound and a polyisocyanate compound. These compositions are particularly suitable for the adhesion of substrates having a low surface energy.

Document WO 2016/077166 relates to a two-part composition comprising a first part comprising an organoborane-amine complex and a reactive diluent, and a second part comprising a decomplexing agent for decomplexing the organoborane-amine complex and at least one polymerizable compound comprising an ethylenic unsaturated bond.

However, in certain cases and despite the complexation of the organoborane with the amine, the adhesive compositions based on reactive monomers can prove to be unstable in the presence of organoborane-amine complexes and can cause problems not just for the storage thereof but also during the use thereof. In addition, the high reactivity of the organoborane-amine complexes does not allow effective control of their reactivity during the crosslinking of the adhesive compositions (in other words, they crosslink very rapidly).

There is therefore a real need to provide a composition enabling satisfactory adhesion, in particular on and between substrates having a low surface energy, the composition being able to be stored for a prolonged period, be used safely and having a controllable reactivity.

### SUMMARY OF THE INVENTION

The invention relates first to a two-component composition comprising:
a part A comprising a complex of borane BH₃ with an amine;
a part B comprising a decomplexing agent for decomplexing the borane and the amine; and

at least one radically polymerizable compound comprising at least one ethylenic bond, this compound being present in at least one of parts A and B.

In some embodiments:
the amine is of formula (I):

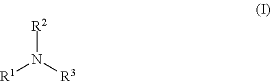

in which R¹, R² and R³ independently represent a hydrogen atom or a group comprising from 1 to 20 carbon atoms, the group being linear or branched and saturated or unsaturated and being chosen from an alkyl group, a cycloalkyl group, or an aryl group;
or the amine is of formula (II):

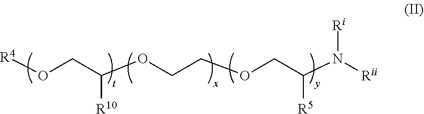

in which R⁴, R⁵ and R¹⁰ independently represent a hydrogen atom or a group comprising from 1 to 10 carbon atoms, the group being linear or branched and saturated or unsaturated and being chosen from an alkyl group, a cycloalkyl group, or an aryl group, Rⁱ and Rⁱⁱ independently represent a hydrogen atom or a group comprising from 1 to 20 carbon atoms, the group being linear or branched and saturated or unsaturated and being chosen from an alkyl group, a cycloalkyl group, an aryl group, or an arylalkyl group, and t, x and y independently represent a number from 0 to 90, preferentially from 0 to 70, preferentially from 0 to 50, and even more preferentially from 0 to 30;
or the amine is of formula (III):

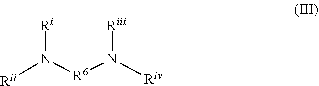

in which R⁶ represents a divalent group comprising from 2 to 60 carbon atoms, and preferably from 2 to 40 carbon atoms, the group being linear or branched and saturated or unsaturated and being chosen from a divalent alkyl radical, a divalent cycloalkyl radical, a divalent arylalkyl radical, or a divalent aryl radical, and Rⁱ, Rⁱⁱ, Rⁱⁱⁱ and R^{iv} independently represent a hydrogen atom or a group comprising from 1 to 20 carbon atoms, the group being linear or branched and saturated or unsaturated and being chosen from an alkyl group, a cycloalkyl group, an aryl group, or an arylalkyl group;
or the amine is of formula (IV):

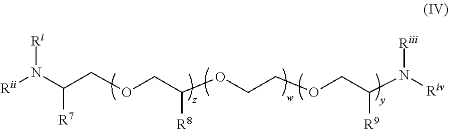

in which R⁷, R⁸ and R⁹ independently represent a group comprising from 1 to 10 carbon atoms, the group being linear or branched and saturated or unsaturated and being chosen from an alkyl group, a cycloalkyl group, or an aryl group, Rⁱ, Rⁱⁱ, Rⁱⁱⁱ and R^{iv} independently represent a hydrogen atom or a group comprising from 1 to 20 carbon atoms, the group being linear or branched and saturated or unsaturated and being chosen from an alkyl group, a cycloalkyl group, an aryl group, or an arylalkyl group, and v, w and z independently represent a number from 0 to 90 and even more preferentially from 0 to 70;
or the amine is of formula (V):

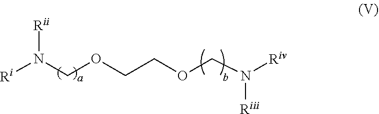

in which Rⁱ, Rⁱⁱ, R^{III} and R^{iv} independently represent a hydrogen atom or a group comprising from 1 to 20 carbon atoms, the group being linear or branched and saturated or unsaturated and being chosen from an alkyl group, a cycloalkyl group, an aryl group, or an arylalkyl group; a and b independently represent a number from 1 to 20 and preferably from 2 to 11;
or the amine is of formula (VI):

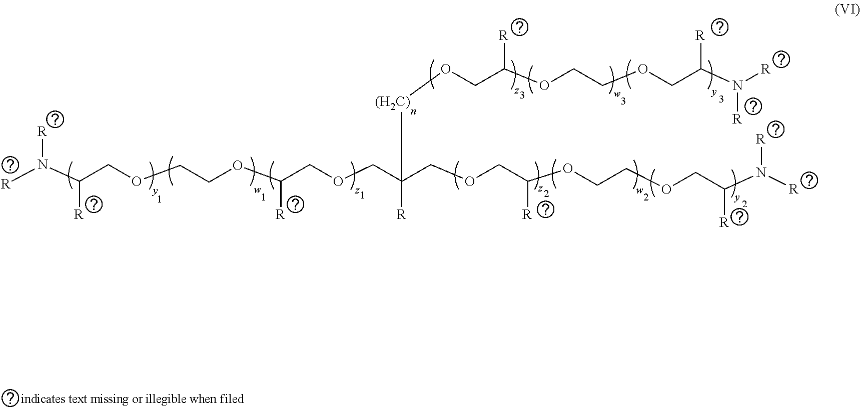

in which R₁⁸, R₁⁹, R₂⁸, R₂⁹, R₂⁹, R₃⁸, and R₃⁹ independently represent a group comprising from 1 to 10 carbon atoms, the group being linear or branched and being chosen from an alkyl group, a cycloalkyl group, or an aryl group, R represents a hydrogen atom or a group comprising from 1 to 10 carbon atoms, the group being linear or branched and being chosen from an alkyl group, a cycloalkyl group, an arylalkyl group, or an aryl group, Rⁱ, Rⁱⁱ, Rⁱⁱⁱ and R^{iv} independently represent a hydrogen atom or a group comprising from 1 to 20 carbon atoms, the group being linear or branched and saturated or unsaturated and being chosen from an alkyl group, a cycloalkyl group, an aryl group, or an arylalkyl group, n represents a number from 0 to 30 and preferably is equal to 0 or 1 and the sums z₁+z₂+z₃, v₁+v₂+v₃ and w₁+w₂+w₃ independently represent a number from 0 to 90, preferentially from 0 to 70, preferentially from 0 to 50 and even more preferentially from 0 to 30.

In certain embodiments, the amine is chosen from diethylamine, triethylamine, diethylaniline, diisopropylamine, diisopropylethylamine, tetramethylpiperidine, tert-butylamine, ethylenediamine, 1,3-propanediamine, a polyetheramine, and combinations thereof.

In certain embodiments, the decomplexing agent is chosen from an isocyanate, a Lewis acid, a carboxylic acid, a mineral acid, a sulfonic acid, a phosphonic acid, an acyl chloride, an anhydride, an aldehyde, a 1,3-dicarbonyl compound, an epoxide, and combinations thereof, and preferably the decomplexing agent is an isocyanate.

In certain embodiments, the radically polymerizable compound is chosen from a styrene, vinyl, acrylic, or methacrylic monomer, and combinations thereof.

In certain embodiments, the radically polymerizable compound is a monomer chosen from an acrylate, an acrylic acid, an acrylamide, an acrylonitrile, a methacrylate, a methacrylic acid, a methacrylamide, a methacrylonitrile, and combinations thereof.

In certain embodiments, the radically polymerizable compound is present only in part B of the composition.

In certain embodiments, the radically polymerizable compound is present only in part A of the composition.

In certain embodiments, the radically polymerizable compound is present in part A and in part B of the composition.

In certain embodiments, the radically polymerizable compound has a content by mass of 10% to 70%, and preferably of 10% to 60%, relative to the total of parts A and B of the composition.

In certain embodiments, the mass ratio of part A to part B is from 0.05 to 20, preferably from 0.1 to 10, and more preferably from 0.1 to 1.

In certain embodiments, the complex of borane BH₃ with an amine is present in part A at a content by mass of 0.1% to 100%, preferably of 1% to 50%, and more preferably of 1% to 25%, relative to the total of part A.

In certain embodiments, the decomplexing agent is present in part B at a content by mass of 0.1% to 70% and preferably of 5% to 60%, relative to the total of part B.

In certain embodiments, the composition also comprises at least one additional amine chosen from a monoamine or a polyamine, preferably at a content by mass of 0.01% to 30%.

In certain embodiments, the composition additionally comprises one or more additives chosen from fillers, plasticizers, tackifying resins, solvents, UV stabilizers, moisture absorbers, fluorescent materials, rheological additives, and combinations thereof.

The invention also relates to the use of the composition as described above as an adhesive for binding two substrates together.

The invention also relates to the use of the composition as described above as a coating on the surface of a substrate.

The invention also relates to the use of the composition as described above as a primer on the surface of a substrate.

In certain embodiments, the substrate or at least one of the two substrates has a surface energy of less than or equal to 45 mJ/m², preferably of less than or equal to 40 mJ/m², and more preferably of less than or equal to 35 mJ/m².

In certain embodiments, the substrate or at least one of the two substrates consists of polyolefin(s), preferably chosen from polyethylene, polypropylene, polybutene, polyisoprene, polybutadiene, polyfarnesene, polymyrcene, polyvinyl fluoride, poly(vinylidene fluoride), polyvinyl difluoride, polyvinyl trifluoride, polytetrafluoroethylene and the copolymers thereof or mixtures thereof.

The invention also relates to an article comprising at least one layer obtained by crosslinking the composition as described above.

In certain embodiments, the layer is an adhesive layer.

The invention also relates to a method for preparing the article described above, comprising:
mixing part A with part B of the composition; and
coating this mixture on the surface of a substrate;
optionally bringing this surface into contact with the surface of an additional substrate.

The present invention makes it possible to meet the need expressed above. It more particularly provides a composition enabling satisfactory adhesion, in particular on and between substrates having a low surface energy, the composition being able to be stored for a prolonged period, be used safely and having a controllable reactivity.

This is accomplished by virtue of the use of a two-component composition (or kit) comprising a borane-amine (i.e. BH₃-amine) complex. The borane-amine complex imparts improved stability to the composition, for example compared to complexes comprising organoboranes, allowing prolonged storage thereof. In addition, due to the greater stability of these complexes compared to the organoborane-amine complexes, the borane-amine complexes enable better control of the reactivity of the composition during its crosslinking.

The possibility of using such a complex satisfactorily is a genuine surprise, insofar as the polymerization mechanism initiated by such a complex is necessarily different from that initiated by an organoborane complex as employed in the prior art.

More particularly, a first part of the composition (part A) comprises this borane-amine complex while a second part of the composition (part B) comprises a decomplexing agent for decomplexing the borane and the amine and for releasing the borane which will initiate the polymerization. Thus, the composition comprises at least one radically polymerizable compound comprising at least one ethylenic bond, which enables its polymerization on the substrate by creating covalent bonds between the polymer and the substrate.

The improved stability of the borane-amine complex makes possible the presence of the radically polymerizable compound in part A of the composition, without posing a risk for the safety or the storage of the composition.

### DETAILED DESCRIPTION

The invention is now described in greater detail and in a nonlimiting way in the description which follows.

The invention relates to a two-component composition comprising a first part (part A) and a second part (part B).

### Borane-Amine Complex

The two-component composition, and more particularly part A of the two-component composition, comprises a complex of borane with an amine.

The term “borane”, or “trihydridoboron” according to systematic nomenclature, is understood to mean a molecule having the formula “BH₃”.

Since borane is a highly reactive molecule, its complexation with an amine is necessary in order to ensure a good storage stability of part A of the adhesive composition.

The amine may be a monoamine (comprising a single amine group) or a polyamine (comprising more than one amine group, for example two, three or four amine groups). In the case of polyamines comprising a main chain, the amine groups may be present at the ends of the main chain and/or in the form of side or pendant groups along the main chain.

Preferably, the amine is a monoamine.

When the amine is a monoamine, it may be chosen from a primary, secondary or tertiary monoamine.

According to certain embodiments, the monoamine can be of formula (I):

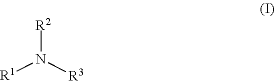

R¹, R² and R³ may independently represent a hydrogen atom or a group comprising from 1 to 20 carbon atoms. This group may be linear or branched and saturated or unsaturated.

According to certain embodiments, R¹, R² and R³ may independently be chosen from an alkyl group, a cycloalkyl group, or an aryl group. By way of example, R¹, R² and R³ may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group (arylalkyl) such as an alkyl phenyl, a phenyl group which is unsubstituted or substituted by one or more groups such as an alkyl group (alkylaryl) or cycloalkyl group, an alkoxy group, a halogen, a nitro group, and a carbonyl group, a naphthyl group which is unsubstituted or substituted by one or more groups such as an alkyl or cycloalkyl group, an alkoxy group, a halogen, a nitro group, and a carbonyl group, a heteroaryl group which is unsubstituted or substituted by one or more groups such as an alkyl or cycloalkyl group, an alkoxy group, a halogen, a nitro group, and a carbonyl group. As examples of heteroaryl groups, mention may be made of pyridines, pyrroles and carbazoles.

Alternatively, two of R¹, R² and R³ may form part of a ring, for example of a pyrrolidine, of a piperidine, of a morpholine, of a thiomorpholine, or of one of the higher homologs thereof. Still alternatively, two of R¹, R² and R³ may form part of several rings such as for example 1-azabicyclo[2.2.2]octane (or quinuclidine).

According to certain embodiments, R¹, R² and R³ may be identical.

According to other embodiments, R¹, R² and R³ may be different from one another.

According to certain embodiments, at least two of R¹, R² and R³ are identical.

According to certain embodiments, at least one of R¹, R² and R³ is a hydrogen.

According to other embodiments, none of R¹, R² and R³ is a hydrogen.

According to preferred embodiments, when the monoamine of formula (I) is a primary amine, it may be tert-butylamine.

According to preferred embodiments, when the monoamine of formula (I) is a secondary amine, it may be diisopropylamine or diethylamine, and preferably diisopropylamine.

According to preferred embodiments, when the monoamine of formula (I) is a tertiary amine, it may be triethylamine, diisopropylethylamine or diethylaniline.

According to other embodiments, the monoamine may be a polyetheramine, i.e. an amine comprising multiple ether functions.

According to preferred embodiments, the monoamine is a primary polyetheramine.

According to other embodiments, the monoamine is a secondary or tertiary polyetheramine.

Thus, in the case of a monoamine which is a polyetheramine, it can be of formula (II):

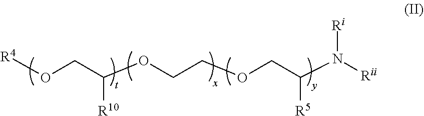

R⁴, R⁵ and R¹⁰ may independently represent a hydrogen atom or a group comprising from 1 to 10 carbon atoms. This group may be linear or branched and saturated or unsaturated. Preferably, R⁴, R⁵ and R¹⁰ independently represent a linear or branched group comprising from 1 to 10 carbon atoms, preferably from 1 to 7 and more preferably from 1 to 3 carbon atoms.

According to certain embodiments, R⁴ may be chosen from an alkyl group, a cycloalkyl group, an arylalkyl group, an aryl group, or an alkylaryl group, the alkyl, cycloalkyl, arylalkyl, aryl and alkylaryl groups being as described above.

Preferably, R⁴ is an alkyl group, preferably comprising from 1 to 7 carbon atoms, and preferably from 1 to 3 carbon atoms.

According to certain embodiments, R⁵ may be chosen from an alkyl group, a cycloalkyl group, or an aryl group, these groups being as described above. Preferably, R⁵ is an alkyl group, preferably comprising from 1 to 2 carbon atoms. More preferably, R⁵ is chosen from a methyl group and an ethyl group.

According to certain embodiments, R¹⁰ may be chosen from an alkyl group, a cycloalkyl group, or an aryl group, the alkyl, cycloalkyl and aryl groups being as described above. Preferably, R¹⁰ is an alkyl group, preferably comprising from 1 to 2 carbon atoms. More preferably, R¹⁰ is chosen from a methyl group and an ethyl group.

According to certain preferred embodiments, R⁴, R⁵ and R¹⁰ may be identical.

According to other embodiments, R⁴, R⁵ and R¹⁰ may be different from one another.

According to preferred embodiments, R⁵ and R¹⁰ are different from one another. For example, one of R⁵ and R¹⁰ may be an ethyl group and the other of R⁵ and R¹⁰ may be a methyl group.

According to preferred embodiments, at least one of R⁴, R⁵ and R¹⁰ is a methyl group.

Rⁱ and Rⁱⁱ may independently represent a hydrogen atom or a group comprising from 1 to 20 carbon atoms. This group may be linear or branched and saturated or unsaturated.

According to certain embodiments, Rⁱ and Rⁱⁱ may independently be chosen from an alkyl group, a cycloalkyl group, an aryl group, or an arylalkyl group. By way of example, Rⁱ and Rⁱⁱ may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkyl phenyl, a phenyl group which is unsubstituted or substituted by one or more groups such as an alkyl or cycloalkyl group, an alkoxy group, a halogen, a nitro group, and a carbonyl group, a naphthyl group which is unsubstituted or substituted by one or more groups such as an alkyl or cycloalkyl group, an alkoxy group, a halogen, a nitro group, and a carbonyl group, a heteroaryl group which is unsubstituted or substituted by one or more groups such as an alkyl or cycloalkyl group, an alkoxy group, a halogen, a nitro group, and a carbonyl group. As examples of heteroaryl groups, mention may be made of pyridines, pyrroles and carbazoles. Alternatively, Rⁱ and Rⁱⁱ may form part of a ring, for example of a pyrrolidine, of a piperidine, of a morpholine, of a thiomorpholine, or of one of the higher homologs thereof.

According to certain preferred embodiments, Rⁱ and Rⁱⁱ are both hydrogen atoms. In this case, it is a primary polyetheramine.

According to other embodiments, at least one of Rⁱ and Rⁱⁱ is a group comprising from 1 to 20 carbon atoms. In this case, it is a secondary polyetheramine.

According to other embodiments, both of Rⁱ and Rⁱⁱ are independently groups comprising from 1 to 20 carbon atoms. In this case, it is a tertiary polyetheramine.

According to certain embodiments, t, x and y may independently represent a number from 0 to 90, preferentially from 0 to 70, preferentially from 0 to 50, and even more preferentially from 0 to 30. Thus, t, x and y may independently represent a number from 0 to 10, or from 10 to 20; or from 20 to 30; or from 30 to 40; or from 40 to 50; or from 50 to 60; or from 60 to 70; or from 70 to 80; or from 80 to 90.

When t is other than 0, the number t represents the number of ethoxy groups substituted by a group R¹⁰ (preferably propoxy groups when R¹⁰ is methyl or butoxy groups when R¹⁰ is ethyl) present in the monoamine of formula (II).

The number t may or may not be an integer. For example, if a mixture of different alkylene oxides is used, t corresponds to the average degree of ethoxylation of the ethoxy groups substituted by a group R¹⁰ (preferably to the average degree of propoxylation when R¹⁰ is methyl or butoxylation when R¹⁰ is ethyl).

When x is other than 0, the number x represents the number of ethoxy groups present in the monoamine of formula (II).

The number x may or may not be an integer. For example, if a mixture of different alkylene oxides is used, x corresponds to the average degree of ethoxylation.

When y is other than 0, the number y represents the number of ethoxy groups substituted by a group R⁵ (preferably propoxy groups when R⁵ is methyl or butoxy groups when R⁵ is ethyl) present in the monoamine of formula (II).

The number y may or may not be an integer. For example, if a mixture of different alkylene oxides is used, y corresponds to the average degree of ethoxylation of the ethoxy groups substituted by a group R⁵ (preferably to the average degree of propoxylation when R⁵ is methyl or butoxylation when R⁵ is ethyl).

When t and y are other than 0, the sum t+y represents the number of ethoxy groups substituted by groups R⁵ and R¹⁰ (preferably propoxy groups when R⁵ and R10 are methyl or butoxy groups when R⁵ and R¹⁰ are ethyl) present in the amine of formula (II).

According to certain embodiments, when t is equal to 0, y is other than 0.

According to other embodiments, when y is equal to 0, t is other than 0.

According to yet other embodiments, in particular when R⁵ and R¹⁰ are different, t and y are both other than 0.

According to certain embodiments, when y and/or t is equal to 0, x is other than 0.

According to other embodiments, when x is equal to 0, y and/or t is other than 0.

The monoamines of formula (II) may have a molecular mass of 200 to 5500 g/mol, and preferably of 500 to 2500 g/mol. For example, the monoamines of formula (II) may have a molecular mass of 200 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol; or of 5000 to 5250 g/mol; or of 5250 to 5500 g/mol.

This type of polyetheramines is for example sold under the name Jeffamine M series by the company Huntsman.

When the amine is a polyamine, it may be chosen from a primary and/or secondary and/or tertiary polyamine. Preferably, it is a primary polyamine, i.e. all of its amine groups are primary amine groups. More preferably, it is a diamine. However, polyamines comprising more than two amine groups (for example three or four) such as polyethyleneimines (PEIs) may be used.

According to certain embodiments, the polyamine can be of formula (III):

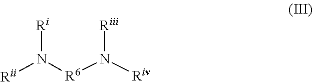

R⁶ may represent a divalent group comprising from 2 to 60 carbon atoms, preferably from 2 to 40 carbon atoms and more preferably from 2 to 15 carbon atoms.

R⁶ may be linear or branched, cyclic or alicyclic, and saturated or unsaturated.

R⁶ may comprise one or more heteroatoms such as an oxygen atom, a sulfur atom, a nitrogen atom or a halogen. Preferably, a single heteroatom may be present in R⁶.

In addition, R⁶ may be chosen from a divalent alkyl radical, a divalent cycloalkyl radical, a divalent alicyclic radical, a divalent arylalkyl radical or a divalent aryl radical. Preferably, R⁶ is an alkyl group.

Rⁱ and Rⁱⁱ are as detailed above.

Rⁱⁱⁱ and R^{iv} may independently represent a hydrogen atom or a group comprising from 1 to 20 carbon atoms. This group may be linear or branched and saturated or unsaturated.

According to certain embodiments, Rⁱⁱⁱ and R^{iv} may independently be chosen from an alkyl group, a cycloalkyl group, an aryl group, or an arylalkyl group. By way of example, Rⁱⁱⁱ and R^{iv} may independently be a methyl group, an ethyl group, an n-propyl group, an isopropyl group, a cyclopropyl group, a tert-butyl group, an isobutyl group, an n-butyl group, a sec-butyl group, a cyclobutyl group, a cyclopentyl group, a cyclohexyl group, an alkyl group substituted by an aryl group such as an alkyl phenyl, a phenyl group which is unsubstituted or substituted by one or more groups such as an alkyl or cycloalkyl group, an alkoxy group, a halogen, a nitro group, and a carbonyl group, a naphthyl group which is unsubstituted or substituted by one or more groups such as an alkyl or cycloalkyl group, an alkoxy group, a halogen, a nitro group, and a carbonyl group, a heteroaryl group which is unsubstituted or substituted by one or more groups such as an alkyl or cycloalkyl group, an alkoxy group, a halogen, a nitro group, and a carbonyl group. As examples of heteroaryl groups, mention may be made of pyridines, pyrroles and carbazoles. Alternatively, Rⁱⁱ and R^{iv} may form part of a ring, for example of a pyrrolidine, of a piperidine, of a morpholine, of a thiomorpholine, or of one of the higher homologs thereof.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ and R^{iv} is a group comprising from 1 to 20 carbon atoms.

According to other embodiments, both of Rⁱ and Rⁱⁱ and/or both of Rⁱⁱ and R^{iv} are independently groups comprising from 1 to 20 carbon atoms.

According to preferred embodiments, the polyamine of formula (III) may be chosen from ethylenediamine, 1,3-propanediamine, 1,5-pentanediamine, 1,6-hexanediamine, 1,1 2-dodecanediamine, 2-methyl-1,5-pentanediamine, 3-methyl-1,5-pentanediamine, isophoronediamine, 4,4′-methylenedianiline, 2-methylbenzene-1,4-diamine, diethylenetriamine, 4,6-diethyl-2-methylbenzene-1,3-diamine, 4,4′-methylenedicyclohexanamine, 2,4,6-trimethyl-1,3-phenylenediamine, and naphthalene-1,8-diamine.

More preferably, the polyamine of formula (III) may be chosen from ethylenediamine and 1,3-propanediamine, and preferably the polyamine of formula (III) is 1,3-propanediamine.

According to other embodiments, the polyamine may be a polyetheramine comprising two amine groups, preferably primary amine groups. Alternatively, the polyamine may be a secondary or tertiary polyamine comprising two amine groups.

Thus, when it is a polyetheramine comprising two amine groups, it can be of formula (IV):

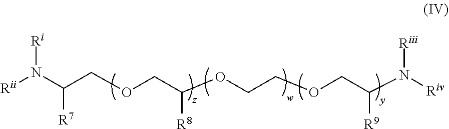

R⁷, R⁸ and R⁹ may independently represent a group comprising from 1 to 10 carbon atoms, preferably from 1 to 6 carbon atoms, and more preferably from 1 to 2 carbon atoms. These groups may be linear or branched and saturated or unsaturated.

R⁷, R⁸ and R⁹ may independently be chosen from an alkyl group, a cycloalkyl group, or an aryl group, these groups being as described above. Preferably, at least one of R⁷, R⁸ and R⁹ is an alkyl group, and more preferably a methyl group or an ethyl group.

According to certain preferred embodiments, R⁷, R⁸ and R⁹ may be identical.

According to other embodiments, R⁷, R⁸ and R⁹ may be different from one another.

According to preferred embodiments, at least one of R⁷, R⁸ and R⁹ is a methyl group, and preferably R⁷, R⁸ and R⁹ are methyl groups.

According to preferred embodiments, R⁸ and R⁹ are different from one another.

According to other embodiments, at least one of R⁸ and R⁹ are methyl groups, and the other of R⁸ and R⁹ ethyl groups.

Rⁱ, Rⁱⁱ, Rⁱⁱⁱ and R^{iv} are as detailed above.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ and R^{iv} is a group comprising from 1 to 20 carbon atoms.

According to other embodiments, both of Rⁱ and Rⁱⁱ and/or both of Rⁱⁱ and R^{iv} are independently groups comprising from 1 to 20 carbon atoms.

According to certain embodiments, v, w and z may independently represent a number from 0 to 90, preferentially from 0 to 70. Thus, v, w and z may independently represent a number from 0 to 10, or from 10 to 20; or from 20 to 30; or from 30 to 40; or from 40 to 50; or from 50 to 60; or from 60 to 70; or from 70 to 80; or from 80 to 90.

According to certain embodiments, z is equal to 0 and v is other than 0.

According to other embodiments, z is other than 0 and v is equal to 0.

According to yet other embodiments, z and v are both other than 0.

When z and v are other than 0, the sum z+v represents the number of substituted ethoxy groups (preferably propoxy or butoxy groups) present in the polyamine of formula (IV).

The sum z+v may or may not be an integer. For example, if a mixture of different alkylene oxides is used, z+v corresponds to the average degree of ethoxylation of the ethoxy groups substituted by R⁸ and R⁹ (preferably to the degree of propoxylation or butoxylation).

When v is equal to 0, the number z represents the number of ethoxy groups substituted by R⁸ (preferably propoxy groups when R⁸ is methyl or butoxy groups when R⁸ is ethyl) present in the polyamine of formula (IV).

When z is equal to 0, the number v represents the number of ethoxy groups substituted by R⁹ (preferably propoxy groups when R⁹ is methyl or butoxy groups when R⁹ is ethyl) present in the polyamine of formula (IV).

The numbers z and v may or may not be integers.

The number w represents the number of ethoxy groups present in the polyamine.

The number w may or may not be an integer. For example, if a mixture of different molecules is used, w corresponds to the average degree of ethoxylation.

According to certain embodiments, v and w may be 0. This type of polyetheramines is for example sold under the names Jeffamine D series and Jeffamine SD series by the company Huntsman.

According to other embodiments, w may be equal to 0, while v is greater than 0.

According to other embodiments, v and w may be greater than 0.

This type of polyetheramines is for example sold under the name Jeffamine ED series by the company Huntsman.

The polyetheramines of formula (IV) may have a molecular mass of 100 to 5000 g/mol, preferably of 200 to 4000 g/mol, preferably of 200 to 2000 g/mol and preferably of 200 to 1000 g/mol. For example, the polyetheramines of formula (IV) may have a molecular mass of 100 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol.

According to other embodiments, the polyetheramine comprising two amine groups can be of formula (V):

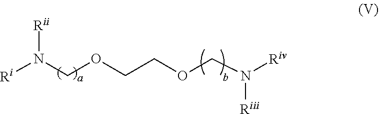

Rⁱ, Rⁱⁱ, R^{III} and R^{iv} are as described above.

According to certain preferred embodiments, Rⁱ and Rⁱⁱ and/or Rⁱⁱⁱ and R^{iv} are all hydrogen atoms.

According to other embodiments, at least one of Rⁱ and Rⁱⁱ and/or at least one of Rⁱⁱⁱ and R^{iv} is a group comprising from 1 to 20 carbon atoms.

According to other embodiments, both of Rⁱ and Rⁱⁱ and/or both of Rⁱⁱ and R^{iv} are independently groups comprising from 1 to 20 carbon atoms.

According to certain embodiments, a and b may independently represent a number from 1 to 20 and preferably from 2 to 11.

According to certain preferred embodiments, a and b are identical. Preferably, a and b are equal to 2 or 3.

According to other embodiments, a and b are different. In this case, at least one of a and b is preferably equal to 2 or 3.

The polyetheramines of formula (V) may have a molecular mass of 150 to 1500 g/mol, preferably of 150 to 1000 g/mol and preferably of 150 to 500 g/mol. For example, the polyetheramines of formula (V) may have a molecular mass of 150 to 160 g/mol; or of 160 to 170 g/mol; or of 170 to 180 g/mol; or of 180 to 190 g/mol; or of 190 to 200 g/mol; or of 200 to 300 g/mol; or of 300 to 400 g/mol; or of 400 to 500 g/mol; or of 500 to 600 g/mol; or of 600 to 700 g/mol; or of 700 to 800 g/mol; or of 800 to 900 g/mol; or of 900 to 1000 g/mol; or of 1000 to 1100 g/mol; or of 1100 to 1200 g/mol; or of 1200 to 1300 g/mol; or of 1300 to 1400 g/mol; or of 1400 to 1500 g/mol.

This type of polyetheramines (formula (V)) is for example sold under the name Jeffamine EDR series by the company Huntsman.

According to other embodiments, the polyamine may be a primary polyetheramine comprising three amine groups. Alternatively, the polyamine may be a secondary or tertiary polyamine comprising three amine groups.

Thus, when it is a polyetheramine comprising three amine groups, it can be of formula (VI):

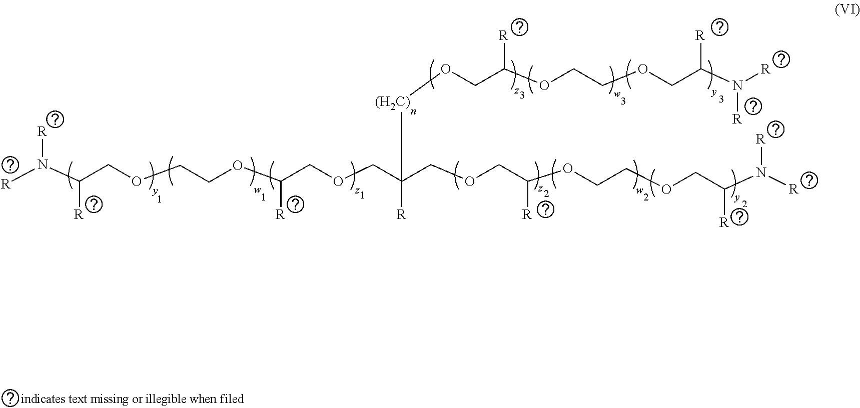

R₁⁸, R₁⁹, R₂⁸, R₂⁹, R₂⁹, R₃⁸, and R₃⁹ may independently represent a group comprising from 1 to 10 carbon atoms, preferably from 1 to 6 carbon atoms, and more preferably from 1 to 2 carbon atoms. These groups may be linear or branched and saturated or unsaturated.

R₁⁸, R₁⁹, R₂⁸, R₂⁹, R₂⁹, R₃⁸, and R₃⁹ may independently be chosen from an alkyl group, a cycloalkyl group, or an aryl group, these groups being as described above. Preferably, at least one of R₁⁸, R₁⁹, R₂⁸, R₂⁹, R₂⁹, R₃⁸, and R₃⁹ is an alkyl group. More preferably R₁⁸, R₁⁹, R₂⁸, R₂⁹, R₂⁹, R₃⁸, and R₃⁹ are chosen from a methyl group or an ethyl group.

According to certain preferred embodiments, R₁⁸, R₁⁹, R₂⁸, R₂⁹, R₂⁹, R₃⁸, and R₃⁹ may be identical, for example they are all a methyl group.

According to other embodiments, R₁⁸, R₁⁹, R₂⁸, R₂⁹, R₂⁹, R₃⁸, and R₃⁹ may be different from one another.

According to certain embodiments, R₁⁸ is different from R₂⁸ and/or R₃⁹.

According to certain embodiments, R₁⁹ is different from R₂⁹ and/or R₃⁹.

According to preferred embodiments, at least one of R₁⁸, R₁⁹ and/or at least one of R₂⁸, R₂⁹ and/or at least one of R₃⁸, R₃⁹ and/or is a methyl group and the other of R₁⁸, R₁⁹ and/or R₂⁸, R₂⁹ and/or R₃⁸, R₃⁹ and/or is an ethyl group.

R may represent a hydrogen atom or a group comprising from 1 to 10 carbon atoms, and preferably from 1 to 3 carbon atoms. This group may be linear or branched.

According to certain embodiments, R may be chosen from an alkyl group, a cycloalkyl group, an arylalkyl group, or an aryl group, the alkyl, cycloalkyl, arylalkyl and aryl groups being as described above.

When R is a group comprising from 1 to 10 carbon atoms, it is preferably an alkyl group, preferably comprising from 1 to 3 carbon atoms, and preferably from 1 to 2 carbon atoms.

According to certain embodiments, R is a hydrogen atom.

According to other embodiments, R is an ethyl group.

Rⁱ, R¹, Rⁱⁱ and R^{iv} are also as detailed above.

According to certain embodiments, z₁, z₂ and z₃ may represent a number from 0 to 80, and preferably from 0 to 70. For example, z₁, z₂ and z₃ may be from 0 to 5; or from 5 to 10; or from 10 to 15; or from 15 to 20; or from 20 to 25; or from 25 to 30; or from 30 to 35; or from 35 to 40; or from 40 to 45; or from 45 to 50; or from 50 to 55; or from 55 to 60; or from 60 to 65; or from 65 to 70; or from 70 to 75; or from 75 to 80. The numbers z₁, z₂ and z₃ may or may not be an integer.

According to certain embodiments, w₁, w₂ and w₃ may represent a number from 0 to 50, and preferably from 0 to 40. For example, w₁, w₂ and w₃ may be from 0 to 5; or from 5 to 10; or from 10 to 15; or from 15 to 20; or from 20 to 25; or from 25 to 30; or from 30 to 35; or from 35 to 40. The numbers w₁, w₂ and w₃ may or may not be an integer.

According to certain embodiments, v₁, v₂ and v₃ may represent a number from 0 to 20, and preferably from 0 to 10. For example, v₁, v₂ and v₃ may be from 0 to 2; or from 2 to 4; or from 4 to 6; or from 6 to 8; or from 8 to 10; or from 10 to 12; or from 12 to 14; or from 14 to 16; or from 16 to 18; or from 18 to 20. The numbers v₁, v₂ and v₃ may or may not be an integer.

According to certain embodiments, at least one of z₁, z₂ and z₃ is other than 0.

According to certain embodiments, at least one of v₁, v₂ and v₃ is other than 0.

According to other embodiments, at least one of z₁, z₂ and z₃ is other than 0, and v₁, v₂ and v₃ are equal to 0.

According to certain embodiments, at least one of w₁, w₂ and w₃ is other than 0.

According to other embodiments, at least one of w₁, w₂ and w₃ is equal to 0, and preferably at least two of w₁, w₂ and w₃ and preferably all three of w₁, w₂ and w₃ are equal to 0.

According to certain embodiments, at least one of v₁ and z₁ is equal to 0 and/or at least one of v₂ and z₂ is equal to 0 and/or at least one of v₃ and z₃ is equal to 0.

According to preferred embodiments, at least one of v₁ and z₁ is equal to 0 and/or at least one of v₂ and z₂ is equal to 0 and/or at least one of v₃ and z₃ is equal to 0 and at least one of w₁, w₂ and w₃ is equal to 0, and preferably at least two of w₁, w₂ and w₃ and preferably all three of w₁, w₂ and w₃ are equal to 0.

The sum w₁+w₂+w₃ represents the number of ethoxy groups present in the polyamine of formula (VI).

The sum v₁+v₂+v₃+z₁+z₂+z₃ represents the number of ethoxy groups substituted by R₁⁸, R₁⁹, R₂⁸, R₂⁹, R₃⁸ and R₃⁹ (preferably propoxy or butoxy groups) present in the polyamine of formula (VI).

The sum v₁+v₂+v₃+z₁+z₂+z₃ may or may not be an integer. For example, if a mixture of different alkylene oxides is used, this sum corresponds to the average degree of ethoxylation of the ethoxy groups substituted by R₁⁸, R₁⁹, R₂⁸, R₂⁹, R₃⁸ and R₃⁹ (preferably to the degree of propoxylation and/or butoxylation).

The sums z₁+z₂+z₃, v₁+v₂+v₃ and w₁+w₂+w₃ may independently represent a number from 0 to 90, preferentially from 0 to 70, preferentially from 0 to 50 and even more preferentially from 0 to 30. Thus, this number may be from 0 to 10; or from 10 to 20; or from 20 to 30; or from 30 to 40; or from 40 to 50; or from 50 to 60; or from 60 to 70; or from 70 to 80; or from 80 to 90.

According to certain embodiments, when w₁, w₂, w₃, z₁, z₂ and z₃ are equal to 0, v₁+v₂+v₃ may be from 2 to 90, and preferably from 4 to 90. For example, this sum may be from 2 to 5; or from 5 to 10; or from 10 to 20; or from 20 to 30; or from 30 to 40; or from 40 to 50; or from 50 to 60; or 60 or 70; or from 70 to 80; or 80 to 90.

The number n may represent a number from 0 to 30, preferably from 1 to 20, and more preferably from 1 to 10. For example, n may be from 0 to 5; or from 5 to 10; or from 10 to 15; or from 15 to 20; or from 20 to 25; or from 25 to 30.

According to certain preferred embodiments, n may be 0 or 1.

The polyetheramines of formula (VI) may have a molecular mass of 300 to 6000 g/mol, preferably of 300 to 5000 g/mol, preferably of 300 to 4000 g/mol and preferably of 300 to 3000 g/mol. For example, the polyetheramines of formula (VI) may have a molecular mass of 300 to 500 g/mol; or of 500 to 750 g/mol; or of 750 to 1000 g/mol; or of 1000 to 1250 g/mol; or of 1250 to 1500 g/mol; or of 1500 to 1750 g/mol; or of 1750 to 2000 g/mol; or of 2000 to 2250 g/mol; or of 2250 to 2500 g/mol; or of 2500 to 2750 g/mol; or of 2750 to 3000 g/mol; or of 3000 to 3250 g/mol; or of 3250 to 3500 g/mol; or of 3500 to 3750 g/mol; or of 3750 to 4000 g/mol; or of 4000 to 4250 g/mol; or of 4250 to 4500 g/mol; or of 4500 to 4750 g/mol; or of 4750 to 5000 g/mol; or of 5000 to 5250 g/mol; or of 5250 to 5500 g/mol; or of 5500 to 5750 g/mol; or of 5750 to 6000 g/mol.

This type of polyetheramines (formula (VI)) is for example sold under the names Jeffamine T series and Jeffamine ST series by the company Huntsman.

In all of the formulae above, the groups with indices t, x, y, v, w, z, vᵢ, wᵢ, and z₁, may or may not be adjacent in the molecule. For example, ethoxy groups may alternate randomly (according to a certain statistical distribution) with propoxy and/or butoxy groups along the same chain.

Alternatively, other types of polyamines that may be used in the context of the present invention are polyethyleneimines (or polyaziridines), that is to say a polymer comprising a repeating unit composed of the amine group and of the biradical “—CH₂CH₂—” group. These polyamines may be linear, branched or dendrimers. Examples include tetraethylenepentamine, EPOMIN SP012 and also the polyethyleneimines of the Lupasol® name (in particular Lupasol® FG) sold by the company BASF.

According to the invention, the borane can form a complex with the amine, with a molar ratio of borane to the amine of 0.1 to 10, and preferably of 0.5 to 5. Preferably, this ratio is from 0.5 to 2. This ratio may in particular be from 0.1 to 0.5; or from 0.5 to 1; or from 1 to 2; or from 2 to 4; or from 4 to 6; or from 6 to 8; or from 8 to 10. For example, when a monoamine is involved, this ratio is preferably approximately 1. However, when a diamine is involved, this ratio is preferably approximately 2.

The borane-amine complex may be present in part A of the composition at a content by mass of 0.1% to 100%, preferably of 1% to 50%, and more preferably of 1% to 25%, relative to the total mass of part A of the composition. This content may in particular be from 0.1% to 1%; or from 1% to 2%; or from 2% to 3%; or from 3% to 4%; or from 4% to 5%; or from 5% to 6%; or from 6% to 7%; or from 7% to 8%; or from 8% to 9%; or from 9% to 10%; or 10% to 11%; or from 11% to 12%; or from 12% to 13%; or from 13% to 14%; or from 14% to 15%; or from 15% to 16%; or from 16% to 17%; or from 17% to 18%; or from 18% to 19%; or from 19% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%; or from 70% to 75%; or from 75% to 80%; or from 80% to 85%; or from 85% to 90%; or from 90% to 95%; or from 95% to 100%.

More particularly, the content of borane-amine complex must be sufficient to allow a complete reaction. On the other hand, a high content of borane-amine complex risks leading to a rapid reaction, which would prevent effective mixing of part A with part B.

According to certain embodiments, the borane-amine complex may be prepared in situ in part A of the composition.

According to other, preferred, embodiments, the borane-amine complex may be prepared before it is introduced into part A of the composition. This preparation may be carried out according to the process described in the patent EP 2189463 or according to the process described in the article by P. Veeraraghavan Ramachandran et al. (Amine-boranes bearing borane-incompatible functionalities: application to selective amine protection and surface functionalization, Chem. Commun., 2016, 52, 11885), for example by reacting an amine as described above with a borohydride compound, such as sodium borohydride, potassium borohydride or lithium borohydride. This reaction may in particular be carried out in the presence of an acid such as an inorganic acid such as sulfuric acid, methanesulfonic acid, hydrochloric acid, nitric acid, boric acid, and preferably in the presence of sulfuric acid.

### Decomplexinq Agent

The two-component composition, and more particularly part B of the two-component composition, comprises a decomplexing agent. The term “decomplexing agent” is understood to mean a compound capable of reacting with the amine present in the borane-amine complex in order to release the borane. The borane will then be able to initiate the polymerization of a monomer present in the composition. Thus, the borane is released after mixing part A of the composition with part B.

The choice of decomplexing agent depends on the nature of the amine (primary, secondary, or tertiary amine).

In the context of the present invention, the decomplexing agent may be chosen from an isocyanate, a Lewis acid, a carboxylic acid, a mineral acid, a phosphonic acid, a sulfonic acid, an acyl chloride, an anhydride, an aldehyde, a 1,3-dicarbonyl compound, and an epoxide. Preferably, the decomplexing agent is an isocyanate.

Compounds derived from diisocyanates such as biurets, uretdiones, isocyanurates, allophanates and oligomeric diisocyanates may also be used as decomplexing agent in the context of the present invention.

Thus, the isocyanate used in the context of the present invention may include any compound comprising at least one and preferably at least two isocyanate groups (polyisocyanates).

By way of example, the two-component composition, and more particularly part B of the composition, may comprise one or more isocyanate compounds chosen from alkylene diisocyanates, cycloalkylene diisocyanates, and aromatic and aliphatic-aromatic diisocyanates.

Specific examples of such types of isocyanate may include ethylene-1,2-diisocyanate, propylene-1,3-diisocyanate, butylene-1,4-diisocyanate, pentamethylene-1,5-diisocyanate (PDI), hexamethylene-1,6-diisocyanate (HDI), toluene-2,4-diisocyanate (2,4-TDI), toluene-2,6-diisocyanate (2,6-TDI), cyclopentylene-1,3-diisocyanate, cyclohexylene-1,4-diisocyanate, cyclohexylene-1,2-diisocyanate, isophorone diisocyanate (IPDI), diphenylmethane-4,4′-diisocyanate (4,4′-MDI), diphenylmethane-2,4′-diisocyanate (2,4′-MDI), diphenylmethane-2,2′-diisocyanate (2,2′-MDI), diphenylpropane-4,4′-diisocyanate (DPDI), m-xylylene diisocyanate (m-XDI), tetramethylxylylene diisocyanate (TMXDI), naphthylene-1,4-diisocyanate, naphthylene-1,5-diisocyanate, m-phenylene diisocyanate (MPDI), p-phenylene diisocyanate (PPDI), diphenylsulfone-4,4′-diisocyanate, furfurylene diisocyanate, 4,4′,4″-triisocyanatotriphenylmethane, benzene-1,3,5-triisocyanate, HDI isocyanurate, TDI isocyanurate, m-XDI isocyanurate, IPDI isocyanurate (VESTANAT® T1890/100 sold by Evonik), an HDI allophanate (Tolonate X FLO 100 sold by Vencorex), HDI biuret, HDI uretdione (Desmodur N 3400 sold by Covestro), glycerol/TDI adduct, TDI/trimethylolpropane adduct, m-XDI/glycerol adduct, m-XDI/trimethylolpropane adduct (Takenate® D-11 ON sold by Mitsui Chemicals), m-H6XDI/trimethylolpropane adduct (Takenate® D-1 20N sold by Mitsui Chemicals).

Preferably, the isocyanate compound used as decomplexing agent may be a prepolymer having at least one isocyanate end obtained for example after the reaction of an isocyanate compound as described above with a polyol or a polyamine. The use of a prepolymer having at least one isocyanate end is advantageous since it can make it possible to obtain part B of the composition with a higher viscosity than in the case in which an isocyanate monomer is used.

The prepolymer may in particular be a polyurethane.

When the decomplexing agent is a Lewis acid, it may for example be chosen from tin chloride or titanium chloride.

When the decomplexing agent is a carboxylic acid, it may for example be chosen from acrylic acid, methacrylic acid, formic acid, acetic acid, 2-ethylhexanoic acid, lauric acid, benzoic acid, and p-methoxybenzoic acid, or from dicarboxylic acids such as oxalic acid, malonic acid, succinic acid, glutaric acid, maleic acid, adipic acid, phthalic acid, fumaric acid, glycolic acid, thioglycolic acid, lactic acid, isophthalic acid and terephthalic acid.

When the decomplexing agent is a mineral acid, it may for example be chosen from hydrochloric acid (HCl), sulfuric acid (H₂SO₄), phosphoric acid (H3PO4), phosphorous acid (H3PO3), hypophosphorous acid (H3PO2) and silicic acid.

When the decomplexing agent is a phosphonic acid, it may for example be chosen from vinylphosphonic acid, phenylphosphonic acid, methylphosphonic acid and octadecylphosphonic acid.

When the decomplexing agent is a sulfonic acid, it may for example be chosen from methanesulfonic acid and benzenesulfonic acid.

When the decomplexing agent is an anhydride, it may for example be chosen from acetic anhydride, propionic anhydride, acrylic anhydride, methacrylic anhydride, hexanoic anhydride, decanoic anhydride, lauric anhydride, benzoic anhydride, maleic anhydride, succinic anhydride, methylsuccinic anhydride, 2-octen-1-ylsuccinic anhydride, 2-dodecen-1-ylsuccinic anhydride, dodecenylsuccinic anhydride, cyclohexanedicarboxylic anhydride, phthalic anhydride, trimellitic anhydride and pyromellitic anhydride.

When the decomplexing agent is an aldehyde, it may for example be chosen from benzaldehyde, o-, m- and p-nitrobenzaldehyde, 2,4-dichlorobenzaldehyde, p-tolylaldehyde and 3-methoxy-4-hydroxybenzaldehyde. Acetals and dialdehydes may also be used.

When the decomplexing agent is a 1,3-dicarbonyl compound, it may for example be chosen from methyl acetoacetate, ethyl acetoacetate, tert-butyl acetoacetate, 2-methacryloyloxyethyl acetoacetate, diethylene glycol bis(acetoacetate), polycaprolactone tris(acetoacetate), polypropylene glycol bis(acetoacetate), poly(styrene-co-allyl acetoacetate), N,N-dimethylacetoacetamide, N-methylacetoacetamide, acetoacetanilide, ethylenebis(acetoacetamide), polypropylene glycol bis(acetoacetamide), acetoacetamide and acetoacetonitrile.

The decomplexing agent may be present in part B of the composition at a content by mass of 0.1% to 70%, and preferably of 10% to 60%, relative to the total mass of part B of the composition. Thus, the content of decomplexing agent in part B may in particular be from 0.1% to 1%; or from 1% to 5%; or from 5% to 10%; or from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%.

More particularly, the contents of borane-amine complex and of decomplexing agent must be adjusted, depending on the acrylic monomer used in the formula, in order to achieve a satisfactory polymerization rate.

### Radically Polymerizable Compound

The two-component composition comprises at least one radically polymerizable compound comprising at least one ethylenic bond. “Radical polymerization” is a chain polymerization which involves radicals as active species. It involves initiation, propagation, termination and chain transfer reactions. Thus, after activation of the borane following its decomplexation from the borane-amine complex, the borane can initiate the polymerization of the polymerizable compound(s) to form a network of polymer(s).

This compound may be present in at least one of the two parts (A and B) of the composition.

According to certain embodiments, the radically polymerizable compound is present only in part A of the composition.

According to other, preferred, embodiments, the radically polymerizable compound is present only in part B of the composition.

According to yet other embodiments, the radically polymerizable compound is present in part A and also in part B of the composition.

The fact that the radically polymerizable compound can be present in part A of the composition in spite of the presence of the borane-amine complex is possible due to the improved stability of this complex compared to an organoborane-amine complex. Thus, the invention has the advantage of being able to provide a part A of stable composition which comprises not only the borane-amine complex, but also the radically polymerizable compound.

The radically polymerizable compound may comprise any monomer, oligomer or polymer, and also mixtures thereof, comprising an olefinic unsaturation and being polymerizable by the radical route. For example, the radically polymerizable compound may be chosen from styrene, vinyl, acrylic and methacrylic monomers. These may include styrene, a-methylstyrene, vinyl esters such as vinyl neodecanoate and vinyl acetate, acrylic and methacrylic monomers or oligomers such as acrylic acid, methacrylic acid, acrylonitrile, methacrylonitrile, acrylic acid amides (or acrylamides), methacrylic acid amides (or methacrylamides), acrylic acid esters (or acrylates) and methacrylic acid esters (or methacrylates).

According to preferred embodiments, the radically polymerizable compound is an acrylic or methacrylic monomer such as acrylic acid, methacrylic acid, acrylonitrile, methacrylonitrile, acrylamides, methacrylamides, acrylates and methacrylates.

The radically polymerizable compound may for example be chosen from acrylic acid, methacrylic acid, acrylate monomers, methacrylate monomers, and mixtures thereof, the alkyl group of the acrylic esters (acrylates) and methacrylic esters (methacrylates) preferably comprising from 1 to 22 carbon atoms, being saturated or unsaturated, linear, branched or cyclic, and possibly including at least one heteroatom (O, S) or one ester function (—COO—); and the alkyl group preferably comprising from 1 to 12 carbon atoms and being linear, branched or cyclic.

Advantageously, the radically polymerizable compound may be chosen from alkyl and cycloalkyl acrylates and methacrylates such as acrylic acid, methyl acrylate, ethyl acrylate, n-propyl acrylate, isopropyl acrylate, allyl acrylate, n-butyl acrylate, isobutyl acrylate, t-butyl acrylate, n-hexyl acrylate, n-octyl acrylate, isooctyl acrylate (SR440 sold by Sartomer), 2-ethylhexyl acrylate, n-decyl acrylate, isodecyl acrylate (SR395 sold by Sartomer), lauryl acrylate (SR335 sold by Sartomer), tridecyl acrylate (SR489 sold by Sartomer), C12-C14 alkyl acrylate (SR336 sold by Sartomer), n-octadecyl acrylate (SR484 sold by Sartomer), C16-C18 alkyl acrylate (SR257C sold by Sartomer), cyclohexyl acrylate, t-butylcyclohexyl acrylate (SR217 sold by Sartomer), 3,3,5-trimethylcyclohexyl acrylate (SR420 sold by Sartomer), isobornyl acrylate (SR506D sold by Sartomer), methacrylic acid, methyl methacrylate, ethyl methacrylate, n-propyl methacrylate, allyl methacrylate, isopropyl methacrylate, n-butyl methacrylate, isobutyl methacrylate, t-butyl methacrylate, cyclohexyl methacrylate, n-hexyl methacrylate, n-octyl methacrylate, isooctyl methacrylate, 2-ethylhexyl methacrylate, isobornyl methacrylate, n-decyl methacrylate, isodecyl methacrylate, n-dodecyl methacrylate, tridecyl methacrylate, and mixtures thereof. Particularly preferred compounds are methyl acrylate, ethyl acrylate, butyl acrylate, 2-ethylhexyl acrylate, methyl methacrylate, ethyl methacrylate, butyl methacrylate and 2-ethylhexyl methacrylate.

In addition, the radically polymerizable compound may be chosen from acrylates and methacrylates comprising heteroatoms, that is to say acrylates and methacrylates which contain at least one atom which is not a carbon or hydrogen in the group of the alcohol part of the ester (without taking into account the atoms of the ester group itself). Preferably, the atom is an oxygen. Thus, the radically polymerizable compound may be chosen from tetrahydrofurfuryl acrylate (SR285 sold by Sartomer), tetrahydrofurfuryl methacrylate (SR203H sold by Sartomer), glycidyl acrylate, 2-hydroxyethyl acrylate, 2- and 3-hydroxypropyl acrylate, 2-methoxyethyl acrylate, 2-ethoxyethyl acrylate, 2- and 3-ethoxypropyl acrylate, 2-(2-ethoxyethoxy)ethyl acrylate (SR256 sold by Sartomer), methoxypolyethylene glycol acrylate (preferably comprising 2 to 8 (ethoxy) repeating units), polyethylene glycol acrylate (preferably comprising 2 to 8 (ethoxy) repeating units), polypropylene glycol acrylate (preferably comprising 2 to 8 (propoxy) repeating units), polycaprolactone acrylate (SR495B sold by Sartomer), 2-phenoxyethyl acrylate (SR339C sold by Sartomer), 2-[2-[2-(2-phenoxyethoxy)ethoxy]ethoxy]ethyl acrylate (SR410 sold by Sartomer), 2-[2-[2-(2-nonylphenoxyethoxy)ethoxy]ethoxy]ethyl acrylate (SR504D sold by Sartomer), cyclic trimethylolpropane formal acrylate (SR531 sold by Sartomer), cyclic glycerol formal acrylate, 2-[2-[2-(2-dodecyloxyethoxy)ethoxy]ethoxy]ethyl acrylate (SR9075 sold by Sartomer), glycidyl methacrylate, 2-hydroxyethyl methacrylate, 2- and 3-hydroxypropyl methacrylate, 2-methoxyethyl methacrylate, 2-ethoxyethyl methacrylate, 2- and 3-ethoxypropyl methacrylate, 2-(2-ethoxyethoxy)ethyl methacrylate, methoxypolyethylene glycol methacrylate (preferably comprising 2 to 8 (ethoxy) repeating units), polyethylene glycol methacrylate (preferably comprising 2 to 8 (ethoxy) repeating units), polypropylene glycol methacrylate (preferably comprising 2 to 8 (propoxy) repeating units), cyclic trimethylolpropane formal methacrylate, cyclic glycerol formal methacrylate (Visiomer® Glyfoma sold by Evonik), and mixtures thereof. Acrylates and methacrylates of ethylene glycol, diethylene glycol, trimethylpropane, triethylene glycol, tetraethylene glycol, dipropylene glycol, tripropylene glycol, tetrapropylene glycol, and pentapropylene may also be used. Particularly preferred compounds are 2-hydroxyethyl acrylate, 2-hydroxypropyl acrylate, polycaprolactone acrylate, 2-hydroxyethyl methacrylate, 2-hydroxypropyl methacrylate and polycaprolactone methacrylate.

Diacrylate and dimethacrylate compounds may also be used within the context of this invention. Such compounds include ethylene glycol diacrylate, 1,3-butylene glycol diacrylate, 1,4-butanediol diacrylate, 1,6-hexanediol diacrylate (SR238 sold by Sartomer), 3-methyl-1,5-pentanediol diacrylate (SR341 sold by Sartomer), cyclohexanedimethanol diacrylate, neopentyl glycol diacrylate, 1,1 0-decanediol diacrylate (SR595 sold by Sartomer), tricyclodecanedimethanol diacrylate (SR833S sold by Sartomer), esterdiol diacrylate (SR606A sold by Sartomer), alkoxylated aliphatic diacrylates such as diethylene glycol diacrylate, triethylene glycol diacrylate (SR272 sold by Sartomer), dipropylene glycol diacrylate (SR508 sold by Sartomer), tripropylene glycol diacrylate (SR306 sold by Sartomer), tetraethylene glycol diacrylate (SR268G sold by Sartomer), ethoxylated and/or propoxylated cyclohexanedimethanol diacrylates, ethoxylated and/or propoxylated hexanediol diacrylates, ethoxylated and/or propoxylated neopentyl glycol diacrylates, caprolactone-modified neopentyl glycol hydroxypivalate diacrylate, dipropylene glycol diacrylate, ethoxylated (3) bisphenol A diacrylate (SR349 sold by Sartomer), ethoxylated (10) bisphenol A diacrylate (SR602 sold by Sartomer), ethoxylated (30) bisphenol A diacrylate, ethoxylated (40) bisphenol A diacrylate, polyethylene glycol (200) diacrylate (SR259 sold by Sartomer), polyethylene glycol (400) diacrylate (SR344 sold by Sartomer), polyethylene glycol (600) diacrylate (SR610 sold by Sartomer), propoxylated neopentyl glycol diacrylates, ethylene glycol dimethacrylate, 1,3-butylene glycol dimethacrylate, 1,4-butanediol dimethacrylate, 1,6-hexanediol dimethacrylate, 3-methyl-1,5-pentanediol dimethacrylate, 1,6-hexanediol monoacrylate monomethacrylate, cyclohexanedimethanol dimethacrylate, neopentyl glycol dimethacrylate, tricyclodecanedimethanol dimethacrylate, alkoxylated aliphatic methacrylates such as triethylene glycol dimethacrylate, tripropylene glycol dimethacrylate, tetraethylene glycol dimethacrylate, ethoxylated and/or propoxylated cyclohexanedimethanol dimethacrylates, ethoxylated and/or propoxylated hexanediol dimethacrylates, ethoxylated and/or propoxylated neopentyl glycol dimethacrylates, caprolactone-modified neopentyl glycol hydroxypivalate dimethacrylate, diethylene glycol dimethacrylate, dipropylene glycol dimethacrylate, tripropylene glycol dimethacrylate, ethoxylated (10) bisphenol A dimethacrylate, ethoxylated (3) bisphenol A dimethacrylate, ethoxylated (30) bisphenol A dimethacrylate, ethoxylated (40) bisphenol A dimethacrylate, polyethylene glycol (200) dimethacrylate, polyethylene glycol (400) dimethacrylate, polyethylene glycol (600) dimethacrylate, ethoxylated and/or propoxylated neopentyl glycol dimethacrylates, and mixtures thereof.

Triacrylate and trimethacrylate compounds may also be used within the context of this invention. Such compounds include glycerol trimethacrylate, glycerol triacrylate, ethoxylated and/or propoxylated glycerol triacrylates, trimethylolpropane triacrylate (SR351 sold by Sartomer), ethoxylated and/or propoxylated trimethylolpropane triacrylates, pentaerythritol triacrylate (SR444D sold by Sartomer), ethoxylated and/or propoxylated trimethylolpropane triacrylates, trimethylolpropane trimethacrylate, and tris(2-hydroxyethyl)isocyanurate triacrylate (SR368 sold by Sartomer), tris(2-hydroxyethyl)isocyanurate trimethacrylate, ethoxylated and/or propoxylated glycerol trimethacrylates, ethoxylated and/or propoxylated trimethylolpropane trimethacrylates, and pentaerythritol trimethacrylate.

Compounds comprising more than three acrylate or methacrylate groups may also be used such as, for example, pentaerythritol tetraacrylate (SR295 sold by Sartomer), ditrimethylolpropane tetraacrylate (SR355 sold by Sartomer), dipentaerythritol pentaacrylate (SR399 sold by Sartomer), ethoxylated and/or propoxylated pentaerythritol tetraacrylates, pentaerythritol tetramethacrylate, ditrimethylolpropane tetramethacrylate, dipentaerythritol pentamethacrylate and ethoxylated and/or propoxylated pentaerythritol tetramethacrylates.

In addition, the radically polymerizable compound may be chosen from acrylic and methacrylic oligomers such as urethane-acrylates and urethane-methacrylates, polyester-acrylates, polyester-methacrylates, polybutadiene-acrylates (SR307 sold by Sartomer) and polybutadiene-methacrylates. Preferred compounds in this category are for example CN1963, CN1964, CN992, CN981, CN9001, CN9002, CN9012, CN9200, CN964A85, CN965, CN966H90, CN991, CN9245S, CN998B80, CN9210, CN9276, CN9209, PR021596, CN9014NS, CN9800, CN9400, CN9167, CN9170A86, CN9761 and CN9165A, sold by Sartomer.

Radically polymerizable compounds which may be used within the context of the invention may also include acrylamides and methacrylamides. For example, these monomers may be chosen from acrylamide, methacrylamide, N-(hydroxymethyl)acrylamide, N-(hydroxyethyl)acrylamide, N-(isobutoxymethyl)acrylamide, N-(3-methoxypropyl)acrylamide, N-[tris(hydroxymethyl)methyl]acrylamide, N-isopropylacrylamide, N-[3-(dimethylamino)propyl]methacrylamide, diacetone acrylamide, N,N′-methylenedimethacrylamide, N,N′-methylenediacrylamide, N,N′-(1,2-dihydroxyethylene)bismethacrylamide and N,N′-(1,2-dihydroxyethylene)bisacrylamide and also from the acrylamides and methacrylamides formed after reaction of acrylic or methacrylic acid (or of the acyl chloride of this acid) with primary and/or secondary (poly)amines such as 1,3-diaminopropane, N,N′-dimethyl-1,3-diaminopropane, 1,4-diaminobutane, polyamidoamines and polyoxyalkylenepolyamines.

According to certain embodiments, a single radically polymerizable compound is present in part A and/or part B of the composition.

According to other embodiments, several radically polymerizable compounds are present in part A and/or part B of the composition.

The radically polymerizable compound(s) may be present in part A and/or part B of the composition at a content by mass of 10% to 70%, and preferably from 10% to 60%, relative to the total mass of part A and/or part B of the composition. This content may for example be from 10% to 15%; or from 15% to 20%; or from 20% to 25%; or from 25% to 30%; or from 30% to 35%; or from 35% to 40%; or from 40% to 45%; or from 45% to 50%; or from 50% to 55%; or from 55% to 60%; or from 60% to 65%; or from 65% to 70%.

### Two-Component Composition

The two-component composition may also comprise at least one additional amine, the additional amine being as defined above.

Preferably, the additional amine is present in part A of the composition. The presence of the amine (in excess relative to the borane) makes it possible to avoid premature decomplexation of the borane, and thus to stabilize the borane-amine complex (and hence part A of the composition) so as to increase its storage life.

According to certain embodiments, this additional amine is the same as the amine present in the borane-amine complex.

According to other embodiments, this additional amine is different from the amine present in the borane-amine complex.

According to certain embodiments, a single additional amine is present in the two-component composition.

According to other embodiments, two or more than two additional amines are present in the two-component composition.

According to preferred embodiments, it is a polyetheramine.

The additional amine may be present in the two-component composition, and preferably in part A of the composition, at a content by mass of 0.01% to 30%, and preferably of 0.01% to 25%, relative to the total mass of the composition and preferably relative to the total mass of part A of the composition. This content may be in particular from 0.01% to 0.5%; or from 0.5% to 1%; or from 1% to 5%; or from 5% to 10%; or from 10% to 15%; or from 15% to 20%; or from 20% to 25%; or from 25% to 30%.

The two-component composition may also comprise one or more additives chosen from fillers, plasticizers, tackifying resins, solvents, UV stabilizers, moisture absorbers, fluorescent materials and rheological additives.

Such additives may be present in one of the two parts of the composition, or alternatively in both parts of the composition.

For example, part A of the two-component composition may comprise fillers, plasticizers, tackifying resins, solvents, UV stabilizers, moisture absorbers, fluorescent materials and rheological additives.

Part B of the two-component composition may for example comprise fillers and plasticizers.

The fillers may be chosen from talc, mica, kaolin, bentonite, aluminum oxides, titanium oxides, iron oxides, barium sulfate, hornblende, amphiboles, chrysotile, carbon black, carbon fibers, fumed or pyrogenic silicas, molecular sieves, calcium carbonate, wollastonite, glass beads, glass fibers, and combinations thereof.

As regards the plasticizer, this may be chosen from those known to a person skilled in the art in the coating or adhesive industries. Mention may be made, for example, of plasticizers based on phthalate, polyol ester (such as, for example, pentaerythritol tetravalerate, sold by Perstorp), epoxidized oil, alkylsulfonic esters of phenol (the Mesamoll® product sold by Lanxess), and mixtures thereof.

The tackifying resin may in particular be chosen from: resins obtained by polymerization of terpene hydrocarbons and of phenols, in the presence of Friedel-Crafts catalysts, such as the Dertophene® 1510 resin available from DRT having a molar mass of approximately 870 Da, Dertophene® H150 available from the same company with a molar mass equal to approximately 630 Da, Sylvarez® TP 95 available from Arizona Chemical having a molar mass of approximately 1200 Da; resins obtained by a process comprising the polymerization of a-methylstyrene such as the Norsolene® W100 resin available from Cray Valley, which is obtained by polymerization of a-methylstyrene without the action of phenols, with a number-average molar mass of 900 Da, Sylvarez® 510 which is also available from Arizona Chemical with a molar mass of approximately 1740 Da, the process for the production of which also comprises the addition of phenols; natural-origin or modified rosins, and derivatives thereof which are hydrogenated, dimerized, polymerized or esterified with monoalcohols or polyols such as the Sylvalite® RE 100 resin which is an ester of rosin and of pentaerythritol available from Arizona Chemical and has a molar mass of approximately 1700 Da; resins obtained by hydrogenation, polymerization or copolymerization of mixtures of unsaturated aliphatic hydrocarbons having approximately 5, 9 or 10 carbon atoms obtained from petroleum fractions; terpene resins; copolymers based on natural terpenes; and acrylic resins having a viscosity at 100° C. of less than 100 Pa·s.

The solvent may be a solvent which is volatile at ambient temperature (temperature of the order of 23° C.). The volatile solvent may, for example, be chosen from alcohols which are volatile at ambient temperature, such as ethanol or isopropanol. The volatile solvent makes it possible, for example, to reduce the viscosity of the two-component composition (of part A and/or of part B) and make the composition easier to apply. The volatile character of the solvent makes it possible for the product, obtained after crosslinking the composition, to no longer contain solvent.

The UV stabilizers may be chosen from benzotriazoles, benzophenones, “hindered” amines, such as bis(2,2,6,6-tetramethyl-4-piperidyl) sebacate, and mixtures thereof. Mention may be made, for example, of the products Tinuvin® 328 or Tinuvin™ 770, sold by BASF.

The fluorescent material may for example be 2,5-thiophenediylbis(5-tert-butyl-1,3-benzoxazole) (Uvitex® OB).

As regards the rheological additives, these may be chosen from those known to a person skilled in the art in the coating or adhesive industries. Mention may be made, for example, of silica (in particular pyrogenic silica), or a micronized amide wax (such as, for example, the Crayvallac series sold by Arkema).

The additives may be present in the two-component composition at a content by mass of 0.01% to 10%, and preferably of 0.01% to 5%, relative to the total mass of the composition. Thus, the additives may in particular be present in the two-component composition at a content by mass of 0.01% to 0.05%; or of 0.05% to 0.1%; or of 0.1% to 0.5%; or of 0.5% to 1%; or of 1% to 1.5%; or of 1.5% to 2%; or of 2% to 2.5%; or of 2.5% to 3%; or of 3% to 3.5%; or of 3.5% to 4%; or of 4% to 4.5%; or of 4.5% to 5%; or of 5% to 5.5%; or of 5.5% to 6%; or of 6% to 6.5%; or of 6.5% to 7%; or of 7% to 7.5%; or of 7.5% to 8%; or of 8% to 8.5%; or of 8.5% to 9%; or of 9% to 9.5%; or of 9.5% to 10%.

Parts A and B of the two-component composition may preferably remain separate until the composition is used. Thus, the decomplexation of the borane and the initiation of the polymerization commence when part A of the composition comes into contact with part B.

The mass ratio of part A of the composition to part B may be from 0.05 to 20, preferably from 0.1 to 10, and more preferably from 0.1 to 1. According to certain preferred embodiments, this ratio may be approximately 1. Thus, the mass ratio of part A of the composition to part B may be from 0.05 to 0.1; or from 0.1 to 0.5; or from 0.5 to 0.8; or from 0.8 to 1; or from 1 to 1.2; or from 1.2 to 2; or from 2 to 4; or from 4 to 6; or from 6 to 8; or from 8 to 10; or from 10 to 20.

### Use of the Composition

The two-component composition according to the invention can be used for the treatment of substrates having a low surface energy. More particularly, the two-component composition according to the invention can be used for the treatment of substrates having a surface energy of less than or equal to 45 mJ/m², preferably of less than or equal to 40 mJ/m², and more preferably of less than or equal to 35 mJ/m². For example, this surface energy may be from 10 to 15 mJ/m²; or from 15 to 20 mJ/m²; or 20 to 25 mJ/m²; or from 25 to 30 mJ/m²; or 30 to 35 mJ/m²; or from 35 to 40 mJ/m²; or from 40 to 45 mJ/m². Substrates exhibiting a low surface energy are, for example, polyolefins such as polyethylene, polypropylene, polybutadiene, polyisoprene, poly(vinylidene fluoride), polytetrafluoroethylene, and also the copolymers thereof. These surface energy values are well known in the prior art.

According to certain embodiments, part A of the composition can be mixed with part B, before coating of the two-component composition (mixture of parts A and B) on the surface of a substrate. Thus, the decomplexation of the borane and the initiation of polymerization commence when the two parts are mixed.

Part A can be mixed with part B at a temperature of 15 to 40° C., and preferably of 20 to 25° C.

The coating of the two-component composition on the surface of the substrate can then be carried out at a temperature of 15 to 40° C., and preferably of 20 to 25° C.

According to other embodiments, one of the two parts A and B of the composition can be coated on the surface of the substrate in a first stage, and in a second stage the second of the two parts can be coated on the surface of the substrate above the first of the two parts. Thus, the decomplexation of the borane and the initiation of the polymerization commence when the second of parts A and B of the composition is coated on the surface of the substrate.

The coating of the first of the two parts of the two-component composition on the surface of the substrate can be carried out at a temperature of 15 to 40° C., and preferably of 20 to 25° C.

The coating of the second of the two parts of the two-component composition on the surface of the substrate can then be carried out at a temperature of 15 to 40° C., and preferably of 20 to 25° C.

According to certain embodiments, in a first stage part A is coated on the surface of the substrate, and then in a second stage part B is coated above part A on the surface of the substrate.

According to other embodiments, in a first stage part A is coated on the surface of the substrate, and then in a second stage part B is coated above part A on the surface of the substrate.

Thus, in both embodiments, the two-component composition can form a layer on the surface of the substrate. This layer may have a thickness of 1 μm to 500 mm, and preferably 10 μm to 100 mm, and more preferably 10 μm to 10 mm.

According to certain embodiments, the two-component composition according to the invention can be used as an adhesive composition, so as to bond two substrates together. Thus, after crosslinking, the composition can form an adhesive layer holding two substrates fixed together. More particularly, after coating the two-component composition on the surface of a substrate, the surface of an additional substrate can be brought into contact with the coated surface, so as to bond the two substrates. According to certain embodiments, bringing the additional substrate into contact with the coated surface, the assembly can be placed under a heating press so as to accelerate the bonding of the two substrates together. The temperature of this press can be for example from 60 to 110° C., and preferably from 80 to 100° C.

Preferably, at least one of the two substrates is a substrate having a low surface energy. The second substrate can also be a substrate having a low surface energy. Alternatively, the second substrate may be a material chosen from paper, a metal such as aluminum, a polymeric material other than low surface energy substrates, such as polyamides, polystyrene, vinyl polymers such as polyvinyl chloride, polyethers, polyurethanes, polyesters, acrylonitrile-butadiene-styrene, poly(methyl methacrylate), and natural or synthetic rubber.

According to other embodiments, the two-component composition according to the invention can be used as a coating on the surface of a substrate. Thus, after crosslinking, the composition can form a layer covering the surface of the substrate in order for example to modify one or more properties of its surface. Preferably, this substrate has a low surface energy, as described above.

According to yet other embodiments, the two-component composition according to the invention can be used as a primer. The term “primer” is understood to mean a layer coated on a substrate so as to improve one or more surface properties of this substrate (for example so as to improve the adhesion of the substrate to a material), so that additional layers can be applied to the substrate comprising the primer layer. For example, the coating of the two-component composition according to the invention on a low surface energy substrate can make it possible to increase the surface energy thereof in order to facilitate the application of another adhesive composition above the two-component composition.

Thus, the articles manufactured after application of the composition according to the invention comprise at least one surface coated with the two-component composition.

When the two-component composition is used as a primer or coating, this is an external surface of the article.

When the two-component composition is used as an adhesive, this is an internal surface of the article, that is to say a surface of the article which is in contact with, for example, another surface of the article, with the two-component composition being located between these two surfaces.

The crosslinked two-component composition may exhibit an elongation at break of greater than or equal to 30%. This elongation at break may be, for example, from 30% to 40%; or from 40% to 50%; or from 50% to 60%; or from 60% to 70%; or from 70% to 80%; or from 80% to 90%; or from 90% to 100%; or greater than 100%.

The elongation at break can be measured according to the standard ISO 37.

The crosslinked two-component composition may exhibit a modulus of elasticity of less than or equal to 100 MPa and more preferably of less than or equal to 60 MPa; it may, for example, be from 1 to 100 MPa, preferably from 3 to 50 MPa.

The modulus of elasticity can be measured according to the standard ISO 37.

### EXAMPLES

The examples that follow illustrate the invention without limiting it.

Eight two-component compositions (A to H) were prepared by mixing a part A with a part B.

Parts A and B were prepared in an amount of 100 g each.

These two parts were mixed at a ratio of 1.

Part A of compositions A to G comprises from 2% to 15% of a borane-amine complex as indicated in the table below. Part A of composition H comprises 6% of a triethylborane-amine complex (comparative example).

| Compositions | Borane-amine complex |
|---|---|
| A | 2% diisopropylamine-borane |
| B | 6% diisopropylamine-borane |
| C | 6% Jeffamine M600-borane |
| D | 6% Jeffamine ED600-borane |
| E | 6% 1,3-propanediamine-bisborane |
| F | 15% Jeffamine ED600-borane |
| G | 15% Jeffamine M600-borane |
| H | 6% 1,3-propanediamine-triethylborane |

As detailed in the table below, part A for each of the compositions A to H comprises:
methyl methacrylate (MMA),
2-hydroxyethyl methacrylate (HEMA),
Jeffamine 02000,
Jeffamine 0230,
a tackifying resin (Dertophen T sold by DIRT),
hydrophilic pyrogenic silica (Aerosil® R202 sold by Evonik).

TABLE 2

| | | | Jeffamine | Jeffamine | Dertophen | Aerosil ® |
|---|---|---|---|---|---|---|
| Compositions | MMA (%) | HEMA (%) | D2000 (%) | D230 (%) | T (%) | 202 (%) |
| A | 32.3 | 12.5 | 26.1 | 2.1 | 21.9 | 3.1 |
| B | 31 | 12 | 25 | 2 | 21 | 3 |
| C | 31 | 12 | 25 | 2 | 21 | 3 |
| D | 31 | 12 | 25 | 2 | 21 | 3 |
| E | 31 | 12 | 25 | 2 | 21 | 3 |
| F | 28 | 10.9 | 22.6 | 1.8 | 19 | 2.7 |
| G | 28 | 10.9 | 22.6 | 1.8 | 19 | 2.7 |
| H | 31 | 12 | 25 | 2 | 21 | 3 |

Part B for each of the eight compositions is identical and comprises 30% methyl methacrylate monomer, 60% of a polyurethane having isocyanate ends and 10% of a urethane diacrylate.

### Example 1

In this example, each two-component composition was coated on a polypropylene substrate to form a layer. This layer was touched with the tip of a pipette every 30 seconds for 5 minutes, then every minute for 15 minutes, and then every 15 minutes for 2 hours, so as to determine the point at which crosslinking is essentially achieved, when the pipette no longer adheres to the layer.

| Compositions | Time (minutes) |
|---|---|
| A | 8 |
| B | 3.30 |
| C | 6 |
| D | 5.30 |
| E | 2 |
| F | 5 |
| G | 4 |
| H | <1 |

Compositions A to G exhibit a relatively longer time to achieve crosslinking than the time for composition H, which allows for a longer working time window.

### Example 2

In this example, for each composition, a sample is produced by injecting the two-component composition into a Teflon mold to produce dumbbell-shaped (H-shaped) test specimens. After crosslinking for 14 days at ambient conditions (temperature 23° C.±1° C., humidity 50%±5%), the elongation at break and the modulus of elasticity were measured using an Instron universal testing machine (at 100 mm/min) according to the standard ISO 37. The results obtained are illustrated in the table below and correspond to an average of five measurements.

| Compositions | Elongation at break (%) | Modulus of elasticity (MPa) |
|---|---|---|
| A | 68 | 5.0 |
| B | 61 | 3.9 |
| C | 45 | 50.5 |
| D | 63 | 22.5 |
| E | 34 | 20 |
| F | — | — |
| G | — | — |
| H | 11 | 201 |

For compositions A to E comprising from 2% to 6% borane-amine complex, the results show that the samples obtained have better mechanical properties (better suppleness and better flexibility) than the sample produced with composition H (comparative). Regarding compositions F and G, the presence of bubbles in the samples did not make it possible for homogeneous results to be obtained.

### Example 3

In this example, each composition (A to H) was coated on a surface (25 mm×12 mm) of a polypropylene substrate having dimensions of 100 mm×25 mm×5 mm. A second substrate of the same type is then brought into contact with the substrate comprising the two-component composition so as to bond the two substrates together. The two substrates are held against one another with clamps for 14 days. The shear strength of the manufactured articles is then tested using a universal testing machine at a rate of 10 mm/min. The values obtained correspond to an average of 3 measurements. The shear strength is reported with the failure mode.

The results are shown in the table below.

| Compositions | Shear strength (MPa) | Failure mode |
|---|---|---|
| A | 1.1 | AF/CF |
| B | 1.3 | AF/CF |
| C | 0.8 | AF |
| D | 0.8 | AF |
| E | 1.1 | AF/CF |
| F | 0.5 | AF |
| G | 1.1 | AF/CF |
| H | 2.5 | CF |

CF = cohesive failure
AF = adhesive failure

It is observed that, despite a shear strength which is slightly lower than that obtained for composition H, the articles manufactured from compositions A to G exhibit good adhesive properties.

1-15. (canceled)

16. A two-component composition comprising:
a part A comprising a complex of borane BH3 with an amine; and
a part B comprising a decomplexing agent for decomplexing the borane and the amine; and
at least one radically polymerizable compound comprising at least one ethylenic bond, this compound being present in at least one of parts A and B.

17. The composition as claimed in claim 16, wherein:
the amine is of formula (I): 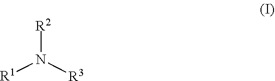
wherein R¹, R² and R³ independently represent a hydrogen atom or a group comprising from 1 to 20 carbon atoms, the group being linear or branched and saturated or unsaturated and being selected from the group consisting of an alkyl group, a cycloalkyl group, and an aryl group;
or the amine is of formula (II): 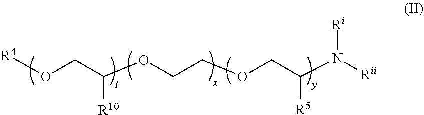
wherein R⁴, R⁵ and R¹⁰ independently represent a hydrogen atom or a group comprising from 1 to 10 carbon atoms, the group being linear or branched and saturated or unsaturated and being selected from the group consisting of an alkyl group, a cycloalkyl group, and an aryl group, R¹ and Rⁱⁱ independently represent a hydrogen atom or a saturated or unsaturated group comprising from 1 to 20 carbon atoms, the group being linear or branched and being selected from the group consisting of an alkyl group, a cycloalkyl group, an aryl group, and an arylalkyl group, and t, x and y independently represent a number from 0 to 90;
or the amine is of formula (III): 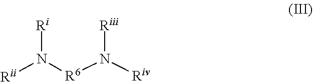
wherein R⁶ represents a divalent group comprising from 2 to 60 carbon atoms, the group being linear or branched and saturated or unsaturated and being selected from the group consisting of a divalent alkyl radical, a divalent cycloalkyl radical, a divalent arylalkyl radical, and a divalent aryl radical, and Rⁱ, Rⁱⁱ, Rⁱⁱⁱ and R^{iv} independently represent a hydrogen atom or a group comprising from 1 to 20 carbon atoms, the group being linear or branched and saturated or unsaturated and being selected from the group consisting of an alkyl group, a cycloalkyl group, an aryl group, and an arylalkyl group;
or the amine is of formula (IV): 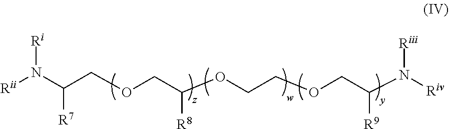
wherein R⁷, R⁸ and R⁹ independently represent a group comprising from 1 to 10 carbon atoms, the group being linear or branched and saturated or unsaturated and being selected from the group consisting of an alkyl group, a cycloalkyl group, and an aryl group, Rⁱ, Rⁱⁱ, Rⁱⁱⁱ and R^{iv} independently represent a hydrogen atom or a group comprising from 1 to 20 carbon atoms, the group being linear or branched and saturated or unsaturated and being selected from the group consisting of an alkyl group, a cycloalkyl group, an aryl group, and an arylalkyl group, and v, w and z independently represent a number from 0 to 90;
or the amine is of formula (V): 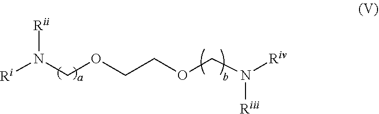
wherein Rⁱ, Rⁱⁱ, Rⁱⁱⁱ and R^{iv} independently represent a hydrogen atom or a group comprising from 1 to 20 carbon atoms, the group being linear or branched and saturated or unsaturated and being selected from the group consisting of an alkyl group, a cycloalkyl group, an aryl group, and an arylalkyl group; a and b independently represent a number from 1 to 20;
or the amine is of formula (VI): 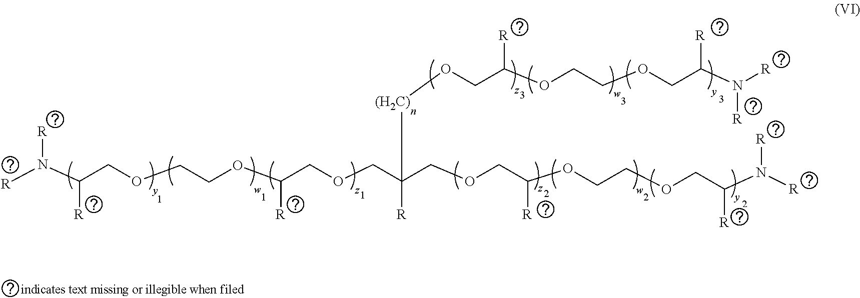
wherein R₁⁸, R₁⁹, R₂⁸, R₂⁹, R₂⁹, R₃⁸, and R₃ ⁹ independently represent a group comprising from 1 to 10 carbon atoms, the group being linear or branched and being selected from the group consisting of an alkyl group, a cycloalkyl group, and an aryl group, R represents a hydrogen atom or a group comprising from 1 to 10 carbon atoms, the group being linear or branched and saturated or unsaturated and being selected from the group consisting of an alkyl group, a cycloalkyl group, an arylalkyl group, and an aryl group, Rⁱ, Rⁱⁱ, Rⁱⁱⁱ and R^{iv} independently represent a hydrogen atom or a group comprising from 1 to 20 carbon atoms, the group being linear or branched and being selected from the group consisting of an alkyl group, a cycloalkyl group, an aryl group, and an arylalkyl group, n represents a number from 0 to 30 and the sums z₁+z₂+z₃, v₁+v₂+v₃ and w₁+w₂+w₃ independently represent a number from 0 to 90.

18. The composition as claimed in claim 16, wherein the decomplexing agent is selected from the group consisting of an isocyanate, a Lewis acid, a carboxylic acid, a mineral acid, a sulfonic acid, a phosphonic acid, an acyl chloride, an anhydride, an aldehyde, a 1,3-dicarbonyl compound, an epoxide, and combinations thereof.

19. The composition as claimed in claim 16, wherein the radically polymerizable compound is selected from the group consisting of a styrene, vinyl, acrylic, and methacrylic monomer, and combinations thereof.

20. The composition as claimed in claim 16, wherein the radically polymerizable compound is present only in part B of the composition, or the radically polymerizable compound is present only in part A of the composition, or the radically polymerizable compound is present in part A and in part B of the composition.

21. The composition as claimed in claim 16, wherein the radically polymerizable compound has a content by mass of 10% to 70%, relative to the total of parts A and B of the composition.

22. The composition as claimed in claim 16, wherein the mass ratio of part A to part B is from 0.05 to 20.

23. The composition as claimed in claim 16, wherein the complex of borane BH₃ with an amine is present in part A at a content by mass of 0.1% to 100%, relative to the total of part A.

24. The composition as claimed in claim 16, wherein the decomplexing agent is present in part B at a content by mass of 0.1% to 70%, relative to the total of part B.

25. An adhesive comprising the composition as claimed in claim 16, wherein the adhesive is used for binding two substrates together, or as a coating on the surface of a substrate, or as a primer on the surface of a substrate.

26. The adhesive as claimed in claim 25, wherein the substrate or at least one of the two substrates has a surface energy of less than or equal to 45 mJ/m².

27. An article comprising at least one layer obtained by crosslinking the composition as claimed in claim 16.

28. The article as claimed in claim 27, wherein the layer is an adhesive layer.

29. A method for preparing the article according to claim 27, comprising:
mixing part A of the composition with part B of the composition; and
coating this mixture on a surface of a substrate;
optionally bringing this surface into contact with a surface of an additional substrate.

30. A method for preparing the article according to claim 27, comprising:
coating one of parts A or B of the composition on a surface of a substrate; and
coating the second of parts A or B of the composition on the surface of the substrate;
optionally bringing this surface into contact with a surface of an additional substrate.

31. The composition as claimed in claim 17, wherein the amine is selected from the group consisting of diethylamine, triethylamine, diethylaniline, diisopropylamine, tert-butylamine, ethylenediamine, 1,3-propanediamine, a polyetheramine, and combinations thereof.
